(19) United States
(12) Patent Application Publication
(10) Pub. No.: US 2022/0058174 A1
(43) Pub. Date: Feb. 24, 2022

(54) SYSTEM AND METHOD FOR REMOVING EXCEPTION PERIODS FROM TIME SERIES DATA

(71) Applicant: Microsoft Technology Licensing, LLC, Redmond, WA (US)

(72) Inventors: Rachel Lemberg, Herzliya (IL); Raphael Fettaya, Tel Aviv (IL); Yaniv Lavi, Tel Aviv-Yafo (IL); Dor Bank, Tel Aviv (IL); Linoy Liat Barel, Tel Aviv (IL)

(21) Appl. No.: 17/001,437

(22) Filed: Aug. 24, 2020

(51) Int. Cl. G06F 16/23

(52) U.S. Cl. CPC G06F 16/2365

(57) ABSTRACT

Exception period data is removed from time series data that may be used for anomaly detection or other purposes. A changed time segment detector is configured to detect pairs of change points in received time series data that define changed time segments. Each detected pair of change points includes start and end points of a corresponding changed time segment. A changed time segment clusterer is configured to cluster the changed time segments into an arranged set of changed time segment clusters. An exception period identifier is configured to identify a changed time segment cluster as an exception period based on heuristics. A time series data indicator is configured to remove time series data corresponding to the exception time period from the received time series data to generate cleaned time series data.

### BACKGROUND

Time series data is a sequence of data points indexed in time order, captured at equally spaced time intervals. Time series data may be captured in any type of system, and for any type of metric that varies over time. For instance, time series data may be captured in a cloud software service/system. Such a system may have numerous cloud service attributes, such as data center, server, error code, etc., where each attribute has multiple possible values with which a time series data may be correlated. Such attributes may be referred to as “behavior,” and the time series data set itself may be referred to as a “multi-dimensional behavioral time series.”

Alert rules may be configured to proactively detect a system's or service's problems. Traditionally, alert rules are applied on various time series data metrics generated by a service or on threshold values that are manually defined. An effective alert rule may be configured to alert when a time series data metric does not behave as expected, while at the same time avoiding too many false positive alerts. Configuring thresholds of time series data metric values with acceptable yet uncertain values is a complex task, benefited by an understanding of the historical behavior of each time series data metric. Deep domain knowledge of the system or service is also applied. Furthermore, a prediction may be made of the time series data metric value ranges corresponding to a normal behavior for the system or service. The challenge scales up when a time series data metric behavior has one or more dimensions, slicing it to multiple time series with different normal behaviors.

For example, in a dynamic environment in which modern services operate, services may undergo frequent updates, and there may be frequent changes to the way services are consumed. This may lead to an ongoing adjustment of both time series data metric alert rules, and the threshold or range of acceptable values. This may also mean repeating the complex task every time a change happens.

Forecasting future time series data metric values based on past behavior is a strategy used in alerting systems, where a prediction mechanism provides not only a predicted single value for a future timestamp metric but an additional time series data metric value range (uncertainty threshold) as a model estimation on the possible prediction error. Anomaly detection is an example usage of such forecasting. It is important for an uncertainty threshold range to be estimated efficiently for an alerting system to perform useful anomaly detection. Too broad a range may result in too few anomalies detected. Too narrow a range may result in too many false anomalies detected.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are configured to provide cleaned time series data to be processed for anomaly detection. Such cleaned time series data has periods of time series removed corresponding to exception periods. The cleaning of time series data may be based partly on historical behavior of metrics associated with computing resources corresponding to a time series. Such cleaning may also be based on the historical behavior of errors or malfunctions of compute metrics or time series data associated with computing resources corresponding to a time series.

In one example aspect, a changed time segment detector is configured to detect pairs of change points in received time series data that define changed time segments. Each detected pair of change points includes start and end points of a corresponding changed time segment. A changed time segment clusterer is configured to cluster the changed time segments into an arranged set of changed time segment clusters. An exception period identifier is configured to identify a changed time segment cluster as an exception period based on heuristics. A time series data indicator is configured to remove time series data corresponding to the exception time period from the received time series data to generate cleaned time series data.

Further features and advantages, as well as the structure and operation of various example embodiments, are described in detail below with reference to the accompanying drawings. It is noted that the example implementations are not limited to the specific embodiments described herein. Such example embodiments are presented herein for illustrative purposes only. Additional implementations will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate example embodiments of the present application and, together with the description, further serve to explain the principles of the example embodiments and to enable a person skilled in the pertinent art to make and use the example embodiments.

FIG. 1 shows a block diagram of an example network-based computing system configured to dynamically remove exception period data from time series, according to an example embodiment.

FIG. 2 is a block diagram of an exception period detection system configured to provide time series data with exception period data removed to an anomaly detector, in accordance with an example embodiment.

FIG. 3 shows a flowchart of a method for removing exception period data from time series data in accordance with an example embodiment.

FIG. 4 depicts a graph showing an anomaly data threshold generated based on time series data without exception period data removed in accordance with an embodiment.

FIG. 5 depicts a graph showing an anomaly data threshold generated based on time series data with exception period data removed in accordance with an embodiment.

FIG. 6 shows a flowchart of a method for performing anomaly detection on cleaned time series data, and adjusting a anomaly data threshold based on detected anomalies, in accordance with an example embodiment.

FIG. 7 shows a flowchart of a method for identifying changed time segments to generate a list of pairs of change points corresponding to changed time segments in accordance with an example embodiment.

FIG. 8 shows a flowchart of a method for detecting changed time segments based on mean distance in accordance with an example embodiment.

FIG. 9 shows a flowchart of a method for removing seasonality in time series data in accordance with an example embodiment.

FIG. 10 is a block diagram of an example processor-based computer system that may be used to implement various embodiments.

The features and advantages of the implementations described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose numerous example implementations. The scope of the present application is not limited to the disclosed implementations, but also encompasses combinations of the disclosed implementations, as well as modifications to the disclosed implementations. References in the specification to “one implementation,” “an implementation,” “an example embodiment,” “example implementation,” or the like, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of persons skilled in the relevant art(s) to implement such feature, structure, or characteristic in connection with other implementations whether or not explicitly described.

In the discussion, unless otherwise stated, adjectives such as “substantially” and “about” modifying a condition or relationship characteristic of a feature or features of an implementation of the disclosure, should be understood to mean that the condition or characteristic is defined to within tolerances that are acceptable for operation of the implementation for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous example embodiments are described as follows. It is noted that any section/subsection headings provided herein are not intended to be limiting. Implementations are described throughout this document, and any type of implementation may be included under any section/subsection. Furthermore, implementations disclosed in any section/subsection may be combined with any other implementations described in the same section/subsection and/or a different section/subsection in any manner.

### II. Example Implementations

Traditionally, alert rules are applied on threshold time series data values (or range of values) that are static or manually defined. An effective alert rule alerts when a time series data metric does not behave as expected, such as an extreme spike or dip in time series data values. A time series data metric behavior may have one or more dimensions, slicing it to multiple time series data with different normal behaviors. This makes more complex the task of configuring thresholds for the variety of multi-dimensional time series data metric behaviors. Moreover, in a modern dynamic environment, services undergo frequent updates and changes to the way the services are consumed. Consequently, ongoing adjustments of the time series data metric alert rules may be needed. This may mean repeating the complex task of configuring threshold time series data values every time an adjustment is needed. Therefore, the challenge of adjusting alert rules may scale up rapidly.

An anomaly data threshold or range for a time series should be configured for a system to provide useful anomaly detections. Creating and using a too-high threshold value or too-wide range may make a prediction useless, allowing some anomalies to go undetected. A threshold too low or range too narrow may result in too many false positives.

Alerting systems widely forecast future metric values based on past behavior. One of the typical usages for forecasting is anomaly detection. For this usage, a prediction mechanism provides a predicted single value for a future timestamp and a range around the value considered as the model estimation on the possible error around the prediction.

Aside from anomalies, from time to time, monitored live systems experience exception periods where flawed data is captured, which may cause captured data to abruptly deviate from acceptable values/ranges. An exception period may be caused in various ways, such as a power outage, a system failure (e.g., software and/or hardware failure), a system malfunction in some way, etc. During an exception period, typically, the system's behavior continues to be recorded by a monitoring system. The recorded behavior includes time series data values that deviate extremely from what normal behavior time series data values would have reflected-without a malfunction. After an exception period has lapsed, due to passage of time, repairs, or other mitigations, the system typically reverts back to its normal behavior, that of prior to the exception period.

Events that trigger exception periods may have a substantial impact on monitoring systems. Traditional, computation models that create predictions for metric behavior would incorporate the erroneous values generated during exception periods. This causes parameters such as variance to grow or shrink immensely. Consequently, unsensitive or inadequate threshold bounds may be generated. With such unsensitive or inadequate threshold bounds there is a potential to miss alerts that would have been triggered if not for the previously recorded time series data of the exception period. This problem is due to exception period's time series data erroneously forming part of the computation model.

One solution that has been used to handle the issue of recorded exception period data forming part of a monitoring system's computational model, has been to build a static computation model. For example, the computation model may be constructed when a system is operational and in “normal” state. The constructed model is then used on incoming new data, without any further updates. This way, no time series data collected when the system experiences an exception period is used to modify the model. A disadvantage to this approach is the lack of adaptive capabilities in the model. This is especially true for live systems, because these systems have constant changes in their incoming time series data behavior. Updating the computational model would require manually reconstructing the model in the background, to adapt the model as needed.

Another tested solution is use a forecasting computational model that incorporates incoming time series data, and simply ignores the fact that values of triggering events and subsequent exception periods would be recorded and form part of the computational model. The justification is that after some duration of time, a model will “forget” the exception period data. Eventually a computational model adapts as it incorporates more and more new data as it is received. However, this may take up a lot of time during which real severe incidents might be missed.

For example, if we have a reliability time series data metric monitored and it is usually within the range of 99.9%-99.99%. Then, for example, a service experiences an exception period for a whole day where the time series data values dropped to 75%. Appearing abnormal for the model constructed on the 99.9% data, one or more alerts may be generated during this period of exception. Subsequently, a fix may be introduced to the service, and the metric data would again reflect a range within 99.9%. Note however that the exception period time series data values would have been recorded and incorporated into the computational model. Then assume that the next day there is another drop to 85% reliability. Clearly this is undesired and not normal (99.9%) behavior for this service and should trigger an alert. However, without specific handling for exception period, a model might consider these 85% reliability time series data values as normal, given that the previous day the values were averaging 75%. Thus, a user would not receive an alert in the second occurrence of deviation from the service's normal behavior.

Embodiments described herein advantageously enable an exception period detection system to dynamically detect exception period data in a time series, remove it from the time series, and generate a cleaned time series to be processed by a computation model. Such embodiments may be implemented as a preprocessing stage, for removing exception period data from a time series and generating cleaned time series data. During this preprocessing state, the exception period data would be discarded, removing from the time series only that data that relates to the exception period. In an embodiment, discarded values of the time series data 118 may be replaced by the median value of time series data 118, or other suitably determined value or set of values. However, noise or other minor deviations in time series data, which are part of a system's normal behavior, would not be designated as forming an exception period nor be removed.

Embodiments described herein would enable a computation model, like the one mentioned above (predicted to operate in the range of 99.9%) to recover more rapidly by labeling as part of the exception period all of those values in 75% range, and discarding the labeled exception period values from time series data. Thereby, the model is enabled to immediately trigger an alert when the values dropped to 85% reliability.

Embodiments described herein enable a system in which exception periods are dynamically and accurately detected and removed from a time series, while avoiding unnecessary interferences or downtime due to false positives or undetected positives. Additionally, the embodiments described herein improve on the functioning of servers and other computing devices for which metrics are being obtained. For example, the detrimental effects of abnormal memory usage, and/or network usage, would be avoided, because the embodiments described herein provide ways for dynamically tracking and removing exception period metrics from a time series within a preprocessing state.

An example embodiment is shown as follows for implementing a preprocessing stage that may efficiently and correctly identify data related to an exception period in a time series:
1) Locate areas of behavior change in the time series:
   a. Identify changes in time series and output a list of change points.
2) Cluster areas to find exception period triggering events:
   a. A triggering event may be identified by at least two types of changes in time series behavior. A first type of change is where a triggering event follows a normal behavioral state. Another type of change is where a triggering event follows the end of exception period. These are two types of change points.
3) Perform heuristic analysis to classify the finding as exception period or not:
   a. Determine whether the clusters form sections to be considered exception periods.

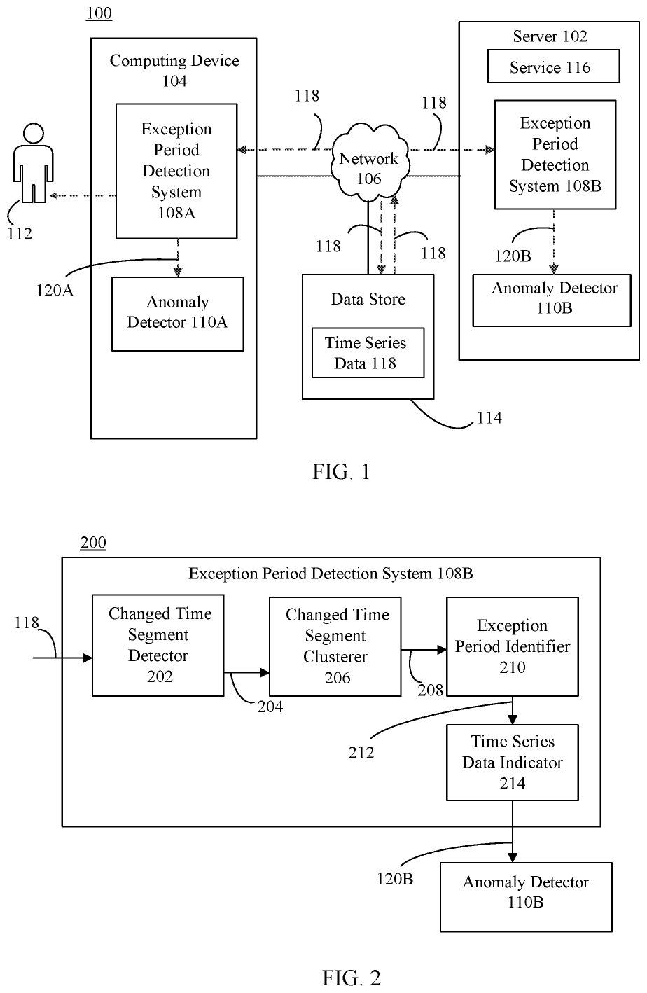

This and many further embodiments for exception period detection and removal are described herein. For instance, FIG. 1 shows a network-based computing system 100 configured to dynamically remove exception period data from time series data in accordance with an example embodiment. As shown in FIG. 1, system 100 includes a server 102, a computing device 104, and a data store 114. A network 106 communicatively couples server 102, computing device 104, and data store 114. Server 102 includes an exception period detection system 108B, which outputs cleaned time series data 120B, and an anomaly detector 110B. Computing device 104 includes an exception period detection system 108A, which outputs cleaned time series data 120A, and an anomaly detector 110A. Data store 114 includes a time series data 118. These features of FIG. 1 are described in further detail as follows.

Network 106 may comprise one or more networks such as local area networks (LANs), wide area networks (WANs), enterprise networks, the Internet, etc., and may include one or more of wired and/or wireless portions. Server 102 may include one or more server devices and/or other computing devices. Computing device 104 may be any type of stationary or mobile computing device, including a mobile computer or mobile computing device (e.g., a Microsoft® Surface® device, a laptop computer, a notebook computer, a tablet computer such as an Apple iPad™, a netbook, etc.), a wearable computing device (e.g., a head-mounted device including smart glasses such as Google® Glass™, etc.), or a stationary computing device such as a desktop computer or PC (personal computer). Computing device 104 may be configured to execute one or more software applications (or “applications”) and/or services and/or manage hardware resources (e.g., processors, memory, etc.), which may be utilized by users (e.g., customers) of the network-accessible server set. Data store 114 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Time series data 118 may be accessible at data store 114 via network 106 (e.g., in a “cloud-based” embodiment), and/or may be local to computing device 104 (e.g., stored in local storage). Server 102 and computing device 104 may include at least one wired or wireless network interface that enables communication with each other and data store 114 (or an intermediate device, such as a Web server or database server) via network 106. Examples of such a network interface include but are not limited to an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, or a near field communication (NFC) interface. Examples of network 106 include a local area network (LAN), a wide area network (WAN), a personal area network (PAN), and/or a combination of communication networks, such as the Internet.

Service 116 in server 102 may comprise any type of network-accessible service that provides one or more applications to end users, such as a database service, social networking service, messaging service, financial services service, news service, search service, productivity service, cloud storage and/or file hosting service, music streaming service, travel booking service, or the like. Examples of such services include but are by no means limited to a web-accessible SQL (structured query language) database, Salesforce.com™, Facebook®, Twitter®, Instagram®, Yammer®, LinkedIn®, Yahoo!® Finance, The New York Times® (at www.nytimes.com), Google™ search, Microsoft® Bing®, Google Docs™, Microsoft® Office 365, Dropbox®, Pandora® Internet Radio, National Public Radio®, Priceline.com®, etc. Although FIG. 1 shows service 116 and exception period detection system 108B both located in server 102, in other embodiments, service 116 and exception period detection system 108B may be located in different, separate servers.

In an embodiment, one or more data stores 114 may be co-located (e.g., housed in one or more nearby buildings with associated components such as backup power supplies, redundant data communications, environmental controls, etc.) to form a datacenter, or may be arranged in other manners. Accordingly, in an embodiment, one or more of data stores 114 may be a datacenter in a distributed collection of datacenters.

Computing device 104 includes exception period detection system 108A, and Server 102 includes exception period detection system 108B. Exception period detection systems 108A-108B are each an embodiment of systems configured for the tracking and removing of exception period data from time series data to generate cleaned time series data 120A-120B, respectively. In embodiments, exception period detection system 108A may be present in computing device 104 and/or exception period detection system 108B may be present in server 102. One may be present without the other, or exception period detection systems 108A and 108B may both be present as illustrated in FIG. 1. What is described about exception period detection system 108A or exception period detection system 108B herein is applicable to both.

As used herein, the terms “time series” and “time series data” refers to a chronologically ordered sequence of data points. Time-series data 118 can be visually represented as a two-dimensional graph. For example, a line graph may plot values of a metric against time, where time is represented on a horizontal axis (e.g., x-axis) and potential values of the metric are represented on a vertical axis (e.g., y-axis). Further, as used herein, the term “exception period” broadly refers to one or more values in time series data 118 which show deviation from a standard time series metric due to an exception event, such as a system outage, a system malfunction, etc. In a line graph, an exception period 212 in time series data 118 may be observed as a spike, a dip, or a persistent spike or dip. An exception period 212 in time series data 118 may correspond to repairable or non-repairable issues. For example, server 102 or service 116 may experience an outage, or server 102 may experience a substantially greater number of errors than other servers in a data center due to a hardware issue, a software issue, and/or a network issue.

As shown in FIG. 1, exception period detection system 108A receives time series data 118 and generates cleaned time series data 120A, and exception period detection system 108B receives time series data 118 and generates cleaned time series data 120B. Anomaly detector 110A receives cleaned time series data 120A and performs anomaly detection on cleaned time series data 120A to detect anomalies when present. Likewise, anomaly detector 110B receives cleaned time series data 120B and performs anomaly detection on cleaned time series data 120B to detect anomalies when present. An “anomaly” is represented by a data point having a value that deviates substantially from the values of the majority of the time series data points, such as by having a value greater than a predetermined threshold or within a predetermined range of data values.

An example system where anomaly detector 110A or anomaly detector 110B are useful is a distributed software services system, where many components run tasks independently, but may appear to end users as a single service. Such distributed services generate a large amount of logs/metrics, which can be converted to time series data 118 in which anomalies can be detected to monitor and improve the behavior of the service 116, for example. Such a distributed service may include a large number of servers, applications, tenants, etc., which can each be considered a dimension against which time series data 118 may be correlated.

The above embodiments, and further embodiments, are described in further detail in the following subsections.

### A. Embodiments for Removing Exception Period Data From Time Series Data

As described herein, exception period detection systems 108A/108B are configured to receive, for input and analysis, time series data 118 to remove time series data 118 corresponding to exception periods 212 and output cleaned time series data 120A/120B. For example, an exception period detection system 108A/108B may receive time series data 118 collected for service 116 directly from service 116 and/or from data store 114 via network 106. Time series data 118 may be collected during execution of service 116 and stored remotely in data store 114 and/or locally in memory of server 102. Time series data 118 may include operational and performance metrics for service 116. Alternatively, the exception period detection system 108A/108B may be configured to receive data for service 116 that needs to be converted to time series data 118 and converts the received data to time series data 118. Exception period detection systems 108A and 108B may be configured in various ways to perform these functions.

For instance, FIG. 2 is a block diagram of a system 200 that includes exception period detection system 108B and anomaly detector 110B, according to an example embodiment. Exception period detection system 108B is configured to generate and provide cleaned time series data 120B to anomaly detector 110B. As shown in FIG. 2, exception period detection system 108B includes a changed time segment detector 202, a changed time segment clusterer 206, an exception period identifier 210, and a time series data indicator 214. These features of system 200 are described in further detail as follows.

As shown in FIG. 2, changed time segment detector 202 receives time series data 118 and generates changed time segments 204. Changed time segment detector 202 is configured to detect pairs of change points in received time series data 118 that define changed time segments 204. Changed time segment detector 202 may detect pairs of change points in time series data 118, including using predetermined threshold values, comparing time series values to averages, and/or any other suitable technique. For instance, in one embodiment, changed time segment detector 202 may implement a change point detection algorithm, such as a variant of the Kernal Change Point Estimate (“KCPE”) algorithm. Such an embodiment is described in further detail below.

In an embodiment, changed time segment detector 202 may perform a variant of the KCPE algorithm as follows:
Changed time segment detector 202 may scale time series 118 using the following formula: x_t=(x_t−x_min)(x_max−x_min). This formula results in values in the range from 0 (zero) to 1 (one).
Changed time segment detector 202 computes gamma, which is the inverse of the 0.8 quantile (0.95 in low dispersion timeseries) of the pairwise distance of the points in time series data 118
Changed time segment detector 202 iterates over the time series data 118 with first and second side-by-side sliding windows of size 32 (thirty-two) (or other size), and at each iteration, computes: M
Changed time segment detector 202 generates a Score=Pairwise(W0)+Pairwise(W1)−Pairwise(W0, W1)
Changed time segment detector 202 decides, if pairwise(WO) is the mean kernel pairwise distance between the points in the first window, to use the Radial Basis Function (“RBF”) kernel with the gamma value computed in the previous step.
Changed time segment detector 202 determines, if the score is approximately zero, there is not a significant difference between the first and second windows, although a high score may indicate there is a change point in one of the two.
Changed time segment detector 202 obtains new time series data 118 with the score computed above on the sliding windows. To locate change points, changed time segment detector 202 searches for the peaks or dips in this new time series data 118, by finding all the local maximums and then applying threshold values against both the width and the height of the spike or dip.

As shown in FIG. 2, changed time segment clusterer 206 receives changed time segments 204 and generates changed time segment clusters 208. In an embodiment, changed time segment clusterer 206 clusters changed time segments 204 into an arranged set in changed time segment clusters 208. An exception period 212 may be identified by two types of changes in the behavior of time series 118. For example, the first type of change may be time series data 118 values that indicate a transition from a normal behavior state to an exception period 212 state. A second type of change may be a transition in time series data 118 behavior from the state of exception period 212 back to the normal behavior state. Changed time segments 204 include data values in the time series data 118 between two change points. Once change points in the time series data 118 are found, a determination is made by changed time segment clusterer 206 of which of the determined changed time segments 204 are part of a same changed time segment 204. Such determination may be made in a variety of ways.

For example, to determine which of determined changed time segments 204 are part of a same changed time segment 204, changed time segment clusterer 206 may first represent all changed time segments 204 by two features: the mean and the standard deviation of its values. This provides a matrix of 2×M where M is the number of sections. On this matrix, changed time segment clusterer 206 may apply a clustering technique, such as hierarchical agglomerative clustering using complete links and the Chebyshev distance. Numerical value 0.7 (or other suitable value) may be used for low-dispersion, and numerical value 0.4 (or other suitable value) may be used for the remaining as the threshold for the distance inside of cluster. For example, two sections may be in the same cluster if the difference between their mean and their standard deviation is smaller than 0.7 (or 0.4).

As shown in FIG. 2, exception period identifier 210 receives changed time segment clusters 208 and generates exception period 212. Exception period identifier 210 may identify exception period 212 in changed time segment cluster 208 in various ways, including through the use of heuristics.

For instance, to determine whether received changed time segment clusters 208 are exception period 212, exception period identifier 210 may implement the following process:
Exception period identifier 210 may group adjacent changed time segment clusters 208 that fall into the same cluster, because the change point separating them is most likely a false positive.
Exception period identifier 210 decides that if a pattern of more than two exception period 212 is found, to not flag or return a value, because this means that time series data 118 is probably unstable.
Exception period identifier 210 indicates changed time segment cluster 208 as an exception period 212 if it complies with one or more of the following conditions:
   the behavior of changed time segment cluster 208 happened only once in a latest time period (e.g., the prior two weeks),
   changed time segment cluster 208 has a duration of more than a predetermined time duration (e.g., two hours, or zero hours in low dispersion metrics),
   changed time segment cluster 208 has a time duration less than a predetermined time duration (e.g., six days),
   the values in exception period 212 are outside of the range of the changed time segment cluster 208 (otherwise it won't impact the prediction)
   the clusters in the sequence before changed time segment cluster 208 and after changed time segment cluster 208 are from the same cluster (the previous behavior is returned to).

As shown in FIG. 2, time series data indicator 214 receives exception period 212 and generates cleaned time series data 120B. Time series data indicator 214 removes time series data 118 from time series data 118 that corresponds to exception period 212, to generate cleaned time series data 120B. Anomaly detector 110B receives cleaned time series data 120B and performs anomaly detection thereon, potentially determining one or more anomalies therein. Anomaly detector 110B may use any suitable techniques for anomaly detection, including supervised or unsupervised techniques, such as a density-based technique (e.g., k-nearest neighbor, etc.), subspace-, correlation-based, and/or tensor-based outlier detection, replicator neural networks, Bayesian networks, hidden Markov models, etc.

For example, anomaly detector 110B may be configured to identify an anomaly in cleaned time series data 120B that exceeds a dynamic threshold. The dynamic threshold may have been determined based on a confidence level associated with a detected time series data 118 behavior. Where an anomaly time series data is detected, anomaly detector 110B may adjust the dynamic threshold based on the detected anomaly.

This process improves the forecasting model, because by discarding exception period 212 before time series data 118 is received by the model, the model may efficiently construct the next forecasting prediction to be used by the monitoring system. Exception period 212 may be removed from time series data 118 in any suitable manner, including discarding data values of the time series that are included in the time range of exception period 212, or replacing the data values of the time series that are included in the time range of exception period 212 with the median value (or other value or set of values) of the time series data 118.

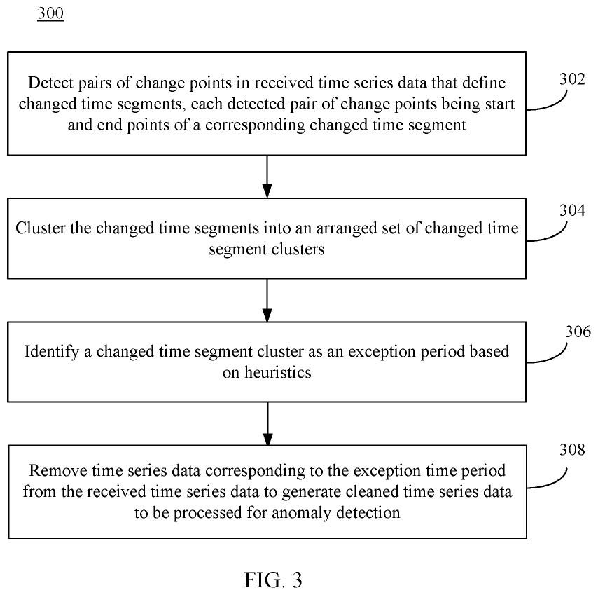

Accordingly, exception period detection systems 108A and 108B may operates in various ways to detect and remove exception period 212 data from time series data 118. For instance, FIG. 3 shows a flowchart 300 of a method for removing exception period data from time series data in accordance with an example embodiment. In an embodiment, flowchart 300 may be implemented by system 200 shown in FIG. 2, although the method is not limited to that implementation. Accordingly, for illustrative purposes, flowchart 300 will be described with continued reference to FIG. 2. Other structural and operational embodiments will be apparent to persons skilled in the relevant art(s) based on the following description of flowchart 300 and system 200 of FIG. 2.

Flowchart 300 begins with step 302. In step 302, pairs of change points are detected in received time series data that define changed time segments, each detected pair of change points being start and end points of a corresponding changed time segment. For example, with reference to FIG. 2, and as described above, changed time segment detector 202 may detect pairs of change points that define changed time segments 204 from time series data 118.

In step 304, the changed time segments are clustered and arranged into a set of changed time segment clusters. For example, with reference to FIG. 2, and as described above, changed time segment clusterer 206 clusters changed time segments 204 into an arranged set of changed time segment clusters 208.

In step 306, exception periods are identified from changed time segment cluster, based on heuristics. For example, with reference to FIG. 2, exception period identifier 210 may receive as input changed time segment clusters 208, and identify exception period 212 in changed time segment cluster 208, based on heuristics, as described above for FIG. 2.

In step 308, time series data corresponding to an exception period is removed from the received time series data to generate cleaned time series data to be processed for anomaly detection. For example, with reference to FIG. 2, time series data indicator 214 may receive as input exception period 212 and remove time series data 118 that corresponds to exception period 212, to generate cleaned time series data 120B. In an embodiment, cleaned time series data 120B may be processed by anomaly detector 110B to determine anomalies, as described above in FIG. 2 description. In other embodiments, cleaned time series data 120B may be processed/used in other ways.

### B. Adjusting Dynamic Thresholds

Embodiments described above are applicable to any anomaly detection system used to adjust dynamic thresholds that are applied to compute metrics. Dynamic thresholds may be adjusted (e.g., tightened or relaxed) based on a confidence level of the uncertainty of a predicted range of time series data 118 values for a particular time series data 118 metric.

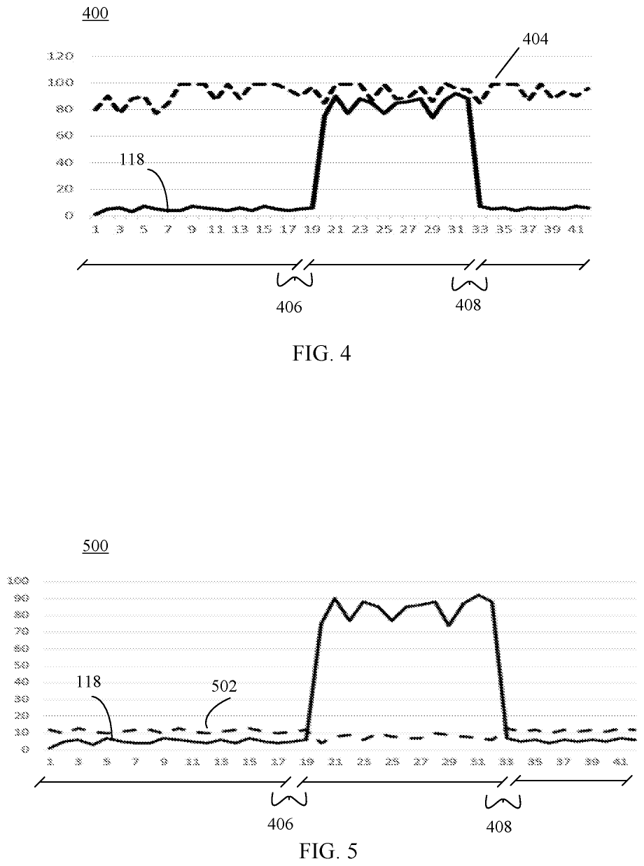

For example, FIG. 4 depicts a plot 400 showing a maximum threshold 404 generated before removing exception period data from time series data 118 in accordance with an embodiment. Traditionally, anomaly detection systems adjust dynamic thresholds based on time series data 118 received as input directly from a computing service. As an example, a reliability metric may usually have values beneath a value of 10 (e.g., 10% of a maximum value). After some time, the corresponding computing service may experience an exception period 212 for a whole day where the values spike to an average of 95. Appearing abnormal for the model constructed on the data with values typically below 10, an alert may be generated during this exception period 212. Subsequently, after the alert, a fix may be introduced to the computing service, and the time series data 118 would again reflect a range within 10. Next, assume that the following day there was another spike in time series data 118 up to an 85 reliability value. Clearly this is undesired and not normal (10%) behavior for this computing service and should trigger an alert. However, without specific handling for exception period 212, a model might consider these 85% reliability values as normal, given that the previous day the time series data 118 values were averaging 95%. Thus, a user might not receive an alert.

Plot 400 of time series data 118 may average a near-zero percent variance in metric values. A dynamic threshold 404 may have been previously adjusted to predict a 95% average uncertainty value range due to an earlier deviation to approximately 95%. As shown in FIG. 4, a time portion 406 of the time series data 118 plot shows a deviation of time series data 118 spiking up to approximately 85%. The exception period 212 here begins at time portion 406 and lasts until a subsequent time portion 408 of the time series data 118 plot, where time series data 118 plot deviates back to zero percent variance average in time series data 118 metric values. However, as illustrated, an alert would not have been triggered due to overly broad dynamic threshold 404. Thus, an anomaly in time series data 118 would not have been detected.

Embodiments described here provide ways for detection and removal of exception period 212, that may allow a model, like the one described above, to recover more rapidly by labeling as part of an exception period 212 those earlier time series data 118 values in the 95% range. If those values would have been discarded from time series data 118, then when values spiked to 85% the model would have immediately triggered an alert.

Accordingly, FIG. 5 depicts a plot 500 showing a maximum threshold generated after removing exception period data from time series data in accordance with an embodiment. For example, FIG. 5 illustrates a dynamic threshold 502 that recovered rapidly and was not impacted by an earlier exception period 212 in the time series data 118. With reference to FIG. 3. and FIG. 2, during step 308 of flowchart 300, time series data indicator 214 removed time series data 118 corresponding to the earlier exception period 212 (recorded between time portion 406 and time portion 408) from the received time series data 118 to generate cleaned time series data 120B. Cleaned time series data 120B may be processed for anomaly detection by anomaly detector 110B. Anomaly detector 110B does not identify a false anomaly corresponding to the time series data from portions 406 and 408, nor would this time series data be used for anomaly threshold generation, because the spike in time series data 118 values were attributed to exception period 212. Consequently, anomaly detector 110B would not have adjusted to an overly broad threshold.

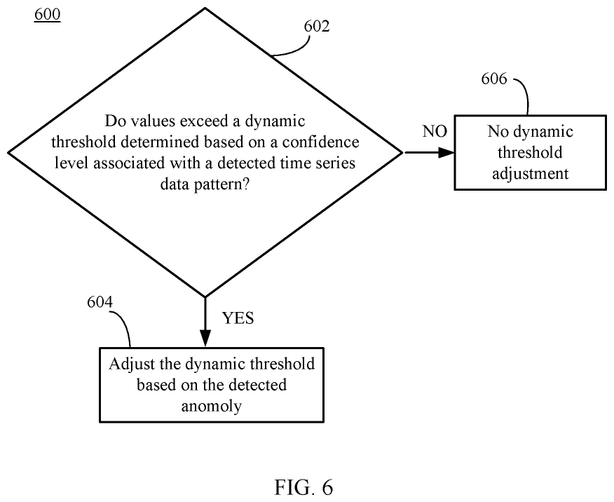

As mentioned above, embodiments of anomaly detectors 110A and 110B may operate in various ways to perform anomaly detection and to adapt dynamic thresholds 502. Such embodiments may be implemented/executed subsequent to a preprocessing stage that removes exception period 212 from time series data and generates cleaned time series data 120A/120B. For instance, exception period detection systems 108A and 108B may each be implemented as a preprocessing stage prior to anomaly detector 110A and 110B, respectively. During this preprocessing state, exception period data 212 is determined and discarded, removing from the time series data 118 only that data that relates to the exception period 212, and optionally replacing the discarded values in time series data 118 with the median value of time series data 118. However, noise or other minor deviations in time series data, which are part of a system's normal behavior, would not be designated as forming an exception period 212 nor be removed. For instance, FIG. 6 shows a flowchart 600 of a method for performing anomaly detection on cleaned time series data 120A/120B, and determining adjustments of dynamic threshold 502, based on detected anomalies, in accordance with an example embodiment. In an embodiment, anomaly detectors 110A and 110B may operate according to flowchart 600. Flowchart 600 is described as follows.

As shown in FIG. 6, flowchart 600 begins at step 602. In step 602, it is determined whether cleaned time series data values exceed a dynamic threshold determined based on a confidence level associated with a detected time series data pattern. For instance, as shown in FIGS. 1 and 3, anomaly detectors 110A and 110B may identify an anomaly in cleaned time series data 120A/120B where time series data values exceed a dynamic threshold 502. The dynamic threshold 502 may have been determined based on a confidence level associated with a detected time series data pattern or behavior. If an anomaly is detected, operation proceeds to step 604. In an anomaly is not detected, operation proceeds to step 606.

In step 604, the dynamic threshold 502 is adjusted based on the detected anomaly.

In an embodiment, when an anomaly is detected, and anomaly detector 110A/110B is configured for dynamic threshold adjustment, anomaly detector 110A/110B may adjust the dynamic threshold 502 based on the detected anomaly. Such an adjustment may be made in any manner, as would be known to persons skilled in the relevant art(s). Operation of flowchart 600 ends after step 604.

In step 606, no dynamic threshold adjustment is made. In an embodiment, where anomaly detector 110A/110B identifies no anomaly, no adjustment is made to the dynamic threshold 502 used for anomaly detection, as illustrated in FIG. 5. Operation of flowchart 600 ends after step 606.

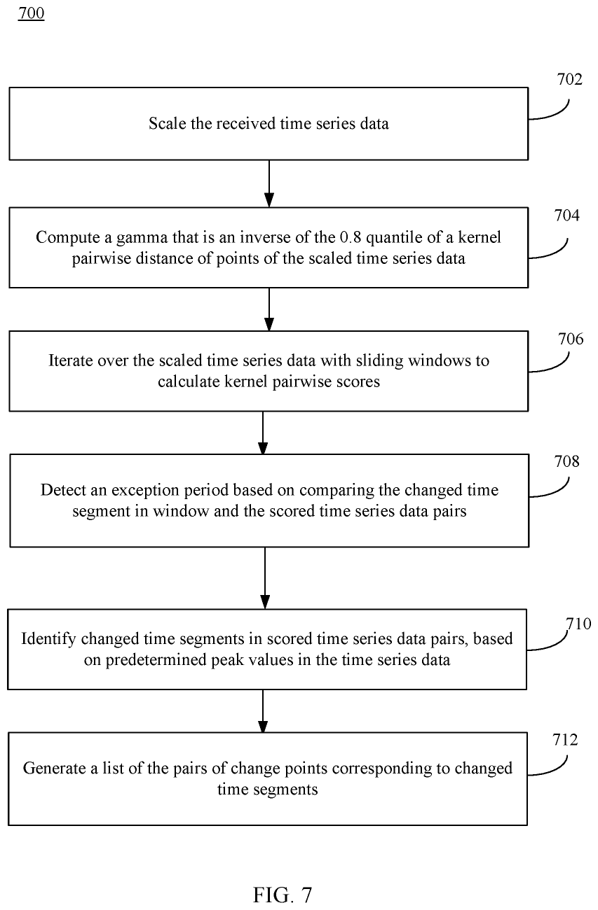

As described above with respect to step 302 of flowchart 300 (FIG. 3), various techniques may be used to identify changed time segments. FIG. 7 shows a flowchart 700 of a method for identifying changed time segments to generate a list of pairs of change points corresponding to changed time segments in accordance with an example embodiment. In an embodiment, flowchart 700 may be performed by changed time segment detector 202 of FIG. 2. Flowchart 700 is described as follows.

As illustrated in FIG. 7, flowchart 700 begins with step 702. In step 702, the received time series data is scaled. In an embodiment, changed time segment detector 202 (from FIG. 2) scales the received time series data 118.

In step 704, a gamma is computed that is an inverse of the 0.8 quantile of a kernel pairwise distance of points of the scaled time series data changed time segment. In an embodiment, changed time segment detector 202 computes a gamma that is an inverse of the 0.8 quantile of the kernel pairwise distance of points of the scaled time series data 118.

In step 706, the scaled time series data is iterated over with sliding windows to calculate kernel pairwise scores. In an embodiment, changed time segment detector 202 iterates over scaled time series data 118 with sliding windows to calculate kernel pairwise scores.

In step 708, an exception period is detected based on comparing the changed time segment in the sliding windows and the scored time series data pairs. In an embodiment, changed time segment detector 202 detects exception period 212 based on comparing the changed time segment 204 in the sliding windows and the scored time series data pairs.

In step 710, changed time segments in scored time series data pairs are identified based on predetermined peak values in the time series data. In an embodiment, changed time segment detector 202 identifies changed time segments 204 in scored time series data pairs, based on predetermined peak values in time series data 118.

In step 712, a list of the pairs of change points corresponding to changed time segments is generated. In an embodiment, changed time segment detector 202 generates a list of the pairs of change points corresponding to changed time segments 204.

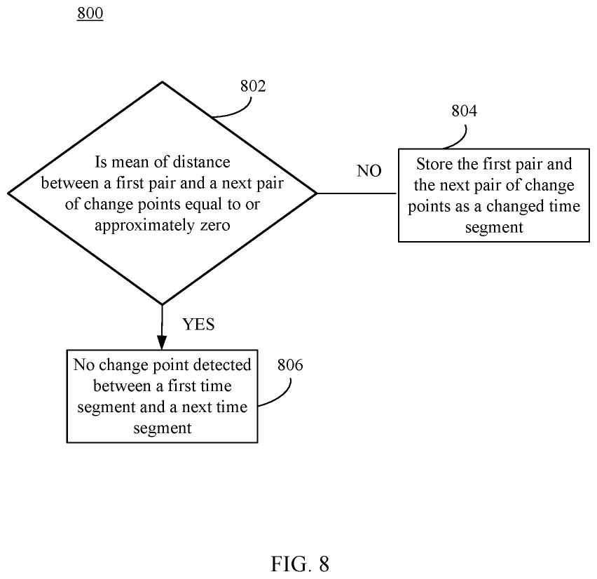

As described above with respect to step 706 of flowchart 700 (FIG. 7), various techniques may be used to iterate over the scaled time series data with sliding windows to calculate kernel pairwise scores. FIG. 8 shows a flowchart 800 of a method for detecting changed time segments based on mean distance in accordance with an example embodiment. In an embodiment, flowchart 800 may be performed during step 706 of flowchart 700, and may be performed by changed time segment detector 202. Flowchart 800 is described as follows.

As illustrated in FIG. 8, flowchart 800 begins with step 802. In step 802, it is determined whether a mean of distance between a first pair and a next pair of change points is equal to or approximately zero. In an embodiment, changed time segment detector 202 iterates over scaled time series data 118 responding to a mean of distance between a first pair and a next pair of change points being equal to or approximately zero. If the mean of distance is not equal to or approximately equal to zero (e.g., is substantially greater than zero), operation proceeds to step 804. If the mean of distance is equal to or approximately equal to zero, operation proceeds to step 806.

In step 804, the first pair and the next pair of change points are stored as a changed time segment. In an embodiment, changed time segment detector 202 iterates over scaled time series data 118 detecting mean of distance between the first pair and the next pair of change points is not equal to or approximately zero, stores the first pair and the next pair of change points as a changed time segment 208.

In step 806, no change point is detected between a first time segment and a next time segment. In an embodiment, as changed time segment detector 202 iterates over scaled time series data 118, the mean of distance detected between the first pair and the next pair of change points is equal to or approximately zero. As such, changed time segment detector 202 determines no change point detected between a first time segment and a next time segment.

As illustrated in FIG. 2, changed time segment detector 202 outputs changed time segments 204 for input to be received by changed time segment clusterer 206.

### C. Seasonality Detector

Seasonality is a variation in a time series that varies at regular intervals over the course of time. Such seasonality may occur over a year on a daily, weekly, monthly, or other basis. Seasonality contributes seasonal information to time series data 118 that varies according to the particular seasonal period. A trend is the general direction of a time series data 118 over longer time periods than seasonality (e.g. trending upwards or downwards). Trend also contributes variation to a time series in the form of trend information. It is noted that seasonality and/or trend may affect the values of time series data, skewing the values higher or lower. It may be desirable to pre-process time series data to remove such seasonality and or trend, to avoid the seasonality and/or trend information changing time series data values enough to cause anomalies to be erroneously detected. As such, time segment detector 202 may be configured to filter out seasonality and/or trend components from time series data 118. Such seasonality and/or trend may be removed in various ways.

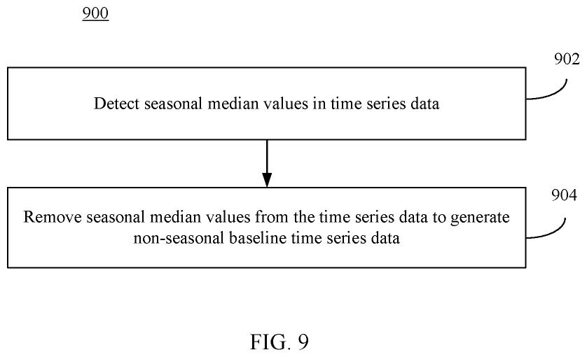

For instance, FIG. 9 shows a flowchart 900 of a method for removing seasonality in time series data in accordance with an example embodiment. Exception period detection system 108A/108B from FIG. 1 may include a seasonality detector to pre-process time series data 118 to decompose the seasonality in time series data 118, for example. This may be achieved by removing seasonal median components from time series data 118. For example, changed time segment detector 202 may include the seasonality detector, which may perform flowchart 900 on time series data 118, and change time segment detector 202 may perform detection on the time series data 118 for seasonality to be removed. It is noted that although flowchart 900 relates to seasonality, and the detection of seasonal median values, in other embodiments, flowchart 900 may similarly be adapted to trend, and the detection of trend median values, as well as being adapted to both seasonality and trend detection simultaneously. Flowchart 900 is described as follows.

As illustrated in FIG. 9, flowchart 900 begins with step 902. In step 902, seasonal median values are detected in time series data. In an embodiment, the seasonality detector detects seasonal median values in time series data 118. For example, a number of service requests to service 116 (FIG. 1) coming from different users 112 (FIG. 1) can form time series data 118. In one example, there may be more service requests on national holidays than on a weekday or regular weekend. Also, more service requests may be made during the day than at night. Both holiday and daily cycles can be considered seasonal data, and may be detected in time series data 118 by the seasonality detector.

In step 904, seasonal median values are removed from the time series data to generate non-seasonal baseline time series data. In an embodiment, the seasonality detector removes seasonal median values from the time series data 118 to generate non-seasonal baseline time series data. In particular, the seasonality detector may be configured to subtract (or add) the detected seasonality values from the corresponding time series data instances. For instance, continuing the above example, both holiday and daily cycles can be considered seasonal data, and therefore can be removed from the time series data 118 by the seasonality detector. For example, the seasonality detector may subtract the value of the detected increase in service requests on a particular holiday from the time series data value corresponding to that particular holiday. Removing the seasonality components may make time series data 118 independent of seasonal cycles, such as holidays or daily cycles.

### III. Example Computer System Implementation

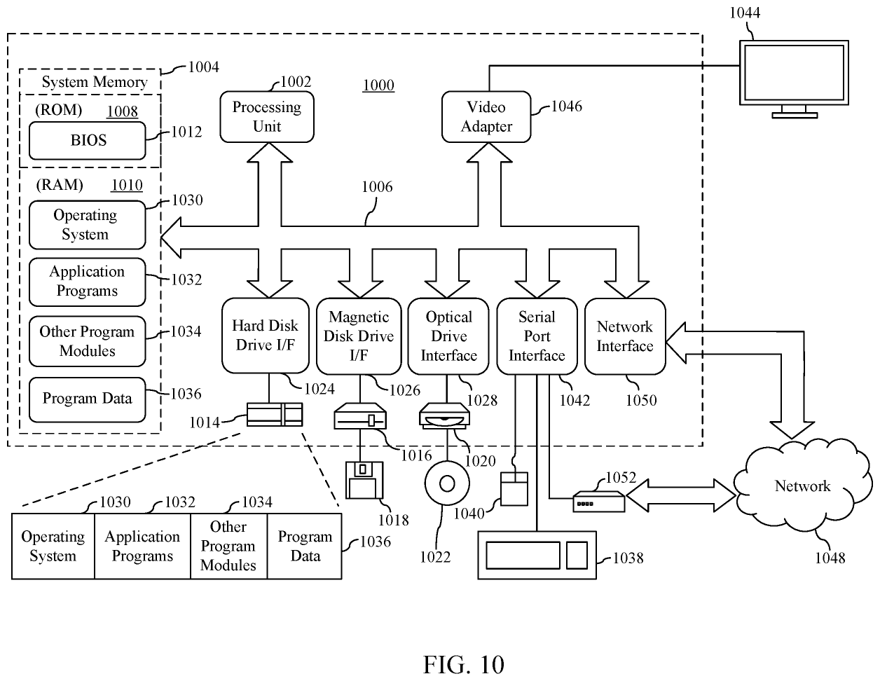

FIG. 10 depicts an example processor-based computer system 1000 that may be used to implement various embodiments described herein. For example, system 1000 may be used to implement any data store 114, and/or server 102, service 116, computing device 104, anomaly detector 110A-110B, and exception period detection system 108A-108B of FIG. 1, changed time segment detector 202, changed time segment clusterer 206, exception period identifier 210, time series data indicator 214, and anomaly detector 110B of FIG. 2. System 1000 may also be used to implement any of the steps of any of the flowcharts of FIGS. 3, 6, 7, 8, and 9 as described above. The description of system 1000 provided herein is provided for purposes of illustration, and is not intended to be limiting. Embodiments may be implemented in further types of computer systems, as would be known to persons skilled in the relevant art(s).

As shown in FIG. 10, system 1000 includes a processing unit 1002, a system memory 1004, and a bus 1006 that couples various system components including system memory 1004 to processing unit 1002. Processing unit 1002 may comprise one or more circuits, microprocessors or microprocessor cores. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

System 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, BLU-RAY™ disk or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable media provide nonvolatile storage of computer-readable instructions, data structures, program modules and other data for the computer. Although a hard disk, a removable magnetic disk and a removable optical disk are described, other types of computer-readable memory devices and storage structures can be used to store data, such as flash memory cards, digital video disks, random access memories (RAMs), read only memories (ROM), and the like.

A number of program modules may be stored on the hard disk, magnetic disk, optical disk, ROM, or RAM. These program modules include an operating system 1030, one or more application programs 1032, other program modules 1034, and program data 1036. In accordance with various embodiments, the program modules may include computer program logic that is executable by processing unit 1002 to perform any or all of the functions and features of any data store 114, and/or server 102, service 116, computing device 104, anomaly detector 110A-110B, and exception period detection system 108A-108B of FIG. 1, changed time segment detector 202, changed time segment clusterer 206, exception period identifier 210, time series data indicator 214, and anomaly detector 110B of FIG. 2., and and/or any of the components respectively described therein, and/or any of the steps of any of the flowcharts of FIGS. 3, 6, 7, 8, and 9 as described above. The program modules may also include computer program logic that, when executed by processing unit 1002, causes processing unit 1002 to perform any of the steps of any of the flowcharts of FIGS. 3, 6, 7, 8, and 9 as described above.

A user may enter commands and information into system 1000 through input devices such as a keyboard 1038 and a pointing device 1040 (e.g., a mouse). Other input devices (not shown) may include a microphone, joystick, game controller, scanner, or the like. In one embodiment, a touch screen is provided in conjunction with a display 1044 to allow a user to provide user input via the application of a touch (as by a finger or stylus for example) to one or more points on the touch screen. These and other input devices are often connected to processing unit 1002 through a serial port interface 1042 that is coupled to bus 1006, but may be connected by other interfaces, such as a parallel port, game port, or a universal serial bus (USB). Such interfaces may be wired or wireless interfaces.

Display 1044 is connected to bus 1006 via an interface, such as a video adapter 1046. In addition to display 1044, system 1000 may include other peripheral output devices (not shown) such as speakers and printers.

System 1000 is connected to a network 1048 (e.g., a local area network or wide area network such as the Internet) through a network interface 1050, a modem 1052, or other suitable means for establishing communications over the network. Modem 1052, which may be internal or external, is connected to bus 1006 via serial port interface 1042.

As used herein, the terms “computer program medium,” “computer-readable medium,” and “computer-readable storage medium” are used to generally refer to memory devices or storage structures such as the hard disk associated with hard disk drive 1014, removable magnetic disk 1018, removable optical disk 1022, as well as other memory devices or storage structures such as flash memory cards, digital video disks, random access memories (RAMs), read only memories (ROM), and the like. Such computer-readable storage media are distinguished from and non-overlapping with communication media (do not include communication media or modulated data signals). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1032 and other program modules 1034) may be stored on the hard disk, magnetic disk, optical disk, ROM, or RAM. Such computer programs may also be received via network interface 1050, serial port interface 1042, or any other interface type. Such computer programs, when executed or loaded by an application, enable system 1000 to implement features of embodiments discussed herein. Accordingly, such computer programs represent controllers of the system 1000. Embodiments are also directed to computer program products comprising software stored on any computer useable medium. Such software, when executed in one or more data processing devices, causes a data processing device(s) to operate as described herein. Embodiments may employ any computer-useable or computer-readable medium, known now or in the future. Examples of computer-readable mediums include, but are not limited to memory devices and storage structures such as RAM, hard drives, floppy disks, CD ROMs, DVD ROMs, zip disks, tapes, magnetic storage devices, optical storage devices, MEMs, nanotechnology-based storage devices, and the like.

In alternative implementations, system 1000 may be implemented as hardware logic/electrical circuitry or firmware. In accordance with further embodiments, one or more of these components may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### IV. Further Example Embodiments

A system for removing exception period data from time series data in accordance with any of the embodiments described herein is also disclosed. The system includes: at least one processor; and a memory that stores program code executable by the at least one processor, the program code including: a changed time segment detector configured to detect pairs of change points in received time series data that define changed time segments, each detected pair of change points being start and end points of a corresponding changed time segment; a changed time segment clusterer configured to cluster the changed time segments into an arranged set of changed time segment clusters; an exception period identifier configured to identify a changed time segment cluster as an exception period based on heuristics; and a time series data indicator configured to remove time series data corresponding to the exception time period from the received time series data to generate cleaned time series data to be processed for anomaly detection.

In one implementation of the foregoing system, the system includes a seasonality detector configured to detect seasonal median values in time series data; and remove seasonal median values from the time series data to generate non-seasonal baseline time series data.

In one implementation of the foregoing system, the system includes: an anomaly detector configured to: identify as an anomaly time series data of the cleaned time series data which have values that exceed a dynamic threshold determined based on a confidence level associated with a detected time series data pattern, and adjust the dynamic threshold based on the detected anomaly.

In one implementation of the foregoing system, the changed time segment detector is configured to detect pairs of change points utilizing a variant of a change point detection algorithm.

In one implementation of the foregoing system, the changed time segment clusterer is configured to identify similar pairs of change time segments based on: a determination of mean values and standard deviations for the time series data sections; and application of a hierarchical agglomerative clustering algorithm to cluster together change time segments based on the determined mean value and standard deviations.

In one implementation of the foregoing system, the exception period identifier is configured to identify an exception period based on a determination of at least one of: the exception period being the only exception period determined in a predetermined prior time period; the exception period having a duration greater than a predetermined time duration; the exception period lasting less than a predetermined amount of time; the data values in the exception period being outside of a range of a predetermined time series data section; or a changed time segment of the exception period as having a preceding changed time segment and a following changed time segment from the same changed time series cluster.

In one implementation of the foregoing system, wherein the changed time segment detector is configured to, to detect pairs of change points_{;} scale received time series data; compute a gamma that is an inverse of a kernel pairwise distance of points of the scaled time series data; iterate over the scaled time series data with sliding windows to calculate kernel pairwise scores; detect an exception period based on comparing the changed time segment in the sliding windows and the scored time series data pairs; identify changed time segments in scored time series data pairs, based on predetermined peak values in the detected time series data pattern; and generate a list of the pairs of change points corresponding to changed time segments.

In one implementation of the foregoing system, where to iterate over the scaled time series data with sliding windows to calculate kernel pairwise scores, the changed time segment detector is configured to: in response to a mean of distance between a first pair and a next pair of change points being equal to or approximately zero, no change point is detected between a first time segment and a next time segment; in response to a mean of kernel pairwise distance between a first pair and a next pair of change points, being substantially greater than zero, store the first pair and the next pair of change points as a changed time segment.

In one implementation of the foregoing system, the hierarchical agglomerative clustering algorithm arranges the changed time segment clusters according to a clock order.

A method is described herein. The method includes: detecting pairs of change points in received time series data that define changed time segments, each detected pair of change points being start and end points of a corresponding changed time segment; clustering the changed time segments into an arranged set of changed time segment clusters; identifying a changed time segment cluster as an exception period based on heuristics; and removing time series data corresponding to the exception time period from the received time series data to generate cleaned time series data to be processed for anomaly detection.

In one implementation of the foregoing method, a seasonality detector includes: detecting seasonal median values in time series data; and removing seasonal median values from time series data to generate non-seasonal baseline time series data.

In one implementation of the foregoing method, the method further includes: identifying as an anomaly time series data of the cleaned time series data which have values that exceed a dynamic threshold determined based on a confidence level associated with a detected time series data pattern, and adjusting the dynamic threshold based on the detected anomaly.

In one implementation of the foregoing method, said detecting comprises detecting pairs of change points utilizing a variant of a change point detection algorithm.

In one implementation of the foregoing method, said identifying includes: determining mean values and standard deviations for the time series data sections; and applying a hierarchical agglomerative clustering algorithm to cluster together changed time segments based on the determined mean value and standard deviations.

In one implementation of the foregoing method, said exception period identification includes: determining the exception period to be the only exception period in a predetermined prior time period; determining the exception period to have a duration greater than a predetermined time duration; determining the exception period lasts less than a predetermined amount of time; determining the data values in the exception period to be outside of a range of a predetermined time series data section; or determining a changed time segment that has a preceding changed time segment and a following changed time segment from the same changed time series cluster.

In one implementation of the foregoing method, said detecting includes: scaling received time series data; computing gamma that is an inverse of the 0.8 quantile of a kernel pairwise distance of points of the scaled time series data; iterating over scaled time series data with sliding windows to calculate kernel pairwise scores; detecting exception period based on comparing the changed time segment in the sliding windows and the scored time series data pairs; identifying changed time segments in scored time series data pairs, based on predetermined peak values in the detected time series data pattern; and generating a list of the pairs of change points corresponding to changed time segments.

In one implementation of the foregoing method, said iterating includes: responding to a mean of distance between a first pair and a next pair of change points being equal to or approximately zero, by indicating no change point detected between a first time segment and a next time segment; and responding to a mean of kernel pairwise distance between a first pair and a next pair of change points, being substantially greater than zero, by indicating to store the first pair and the next pair of change points as a changed time segment.

In one implementation of the foregoing method, said hierarchical agglomerative clustering algorithm includes: arranging the changed time segment clusters according to a clock order.

In one implementation of the foregoing method, said cleaned time series data comprises non-seasonal baseline time series data.

A computer-readable storage medium having program instructions recorded thereon that, when executed by at least one processor, perform a method that includes: detecting pairs of change points in received time series data that define changed time segments, each detected pair of change points being start and end points of a corresponding changed time segment; clustering the changed time segments into an arranged set of changed time segment clusters; identifying a changed time segment cluster as an exception period based on heuristics; and removing time series data corresponding to the exception time period from the received time series data to generate cleaned time series data to be processed for anomaly detection.

### V. Conclusion

While various example embodiments have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosure should not be limited by any of the above-described example embodiments, but should be defined only in accordance with the following claims and their equivalents.

What is claimed is:

1. A system for removing exception period data from time series data for anomaly detection, comprising:
at least one processor; and
a memory that stores program code executable by the at least one processor, the program code including:
a changed time segment detector configured to detect pairs of change points in received time series data that define changed time segments, each detected pair of change points being start and end points of a corresponding changed time segment;
a changed time segment clusterer configured to cluster the changed time segments into an arranged set of changed time segment clusters;
an exception period identifier configured to identify a changed time segment cluster as an exception period based on heuristics; and
a time series data indicator configured to remove time series data corresponding to the exception time period from the received time series data to generate cleaned time series data to be processed for anomaly detection.

2. The system of claim 1, further comprising a seasonality detector configured to detect seasonal median values in time series data; and
remove seasonal median values from the time series data to generate non-seasonal baseline time series data.

3. The system of claim 1, further comprising:
an anomaly detector configured to:
identify as an anomaly time series data of the cleaned time series data which have values that exceed a dynamic threshold determined based on a confidence level associated with a detected time series data pattern, and
adjust the dynamic threshold based on the detected anomaly.

4. The system of claim 1, wherein the changed time segment detector is configured to detect pairs of change points utilizing a variant of a change point detection algorithm.

5. The system of claim 1, wherein the changed time segment clusterer is configured to identify similar pairs of change time segments based on:
a determination of mean values and standard deviations for the time series data sections; and
application of a hierarchical agglomerative clustering algorithm to cluster together change time segments based on the determined mean value and standard deviations.

6. The system of claim 1, wherein the exception period identifier is configured to identify an exception period based on a determination of at least one of:
the exception period being the only exception period determined in a predetermined prior time period;
the exception period having a duration greater than a predetermined time duration;
the exception period lasting less than a predetermined amount of time;
the data values in the exception period being outside of a range of a predetermined time series data section; or
a changed time segment of the exception period as having a preceding changed time segment and a following changed time segment from the same changed time series cluster.

7. The system of claim 4, wherein the changed time segment detector is configured to, to detect pairs of change points_{;}
scale received time series data;
compute a gamma that is an inverse of the 0.8 quantile of a kernel pairwise distance of points of the scaled time series data;
iterate over the scaled time series data with sliding windows to calculate kernel pairwise scores;
detect an exception period based on comparing the changed time segment in the sliding windows and the scored time series data pairs;
identify changed time segments in scored time series data pairs, based on predetermined peak values in the detected time series data pattern; and
generate a list of the pairs of change points corresponding to changed time segments.

8. The system of claim 7, wherein to iterate over the scaled time series data with sliding windows to calculate kernel pairwise scores, the changed time segment detector is configured to:
In response to a mean of distance between a first pair and a next pair of change points being equal to or approximately zero, no change point is detected between a first time segment and a next time segment;
In response to a mean of kernel pairwise distance between a first pair and a next pair of change points being substantially greater than zero, store the first pair and the next pair of change points as a changed time segment.

9. The system of claim 5, wherein the hierarchical agglomerative clustering algorithm arranges the changed time segment clusters according to a clock order.

10. A method for removing exception period data from time series data for anomaly detection, comprising:
detecting pairs of change points in received time series data that define changed time segments, each detected pair of change points being start and end points of a corresponding changed time segment;
clustering the changed time segments into an arranged set of changed time segment clusters;
identifying a changed time segment cluster as an exception period based on heuristics; and
removing time series data corresponding to the exception time period from the received time series data to generate cleaned time series data to be processed for anomaly detection.

11. The method of claim 10, wherein a seasonality detector comprises:
detecting seasonal median values in time series data; and
removing seasonal median values from time series data to generate non-seasonal baseline time series data.

12. The method of claim 10, further comprising:
identifying as an anomaly time series data of the cleaned time series data which have values that exceed a dynamic threshold determined based on a confidence level associated with a detected time series data pattern, and
adjusting the dynamic threshold based on the detected anomaly.

13. The method of claim 10, wherein said detecting comprises detecting pairs of change points utilizing a variant of a change point detection algorithm.

14. The method of claim 10, wherein said identifying comprises:
determining mean values and standard deviations for the time series data sections; and
applying a hierarchical agglomerative clustering algorithm to cluster together changed time segments based on the determined mean value and standard deviations.

15. The method of claim 10, wherein said exception period identification comprises:
determining the exception period to be the only exception period in a predetermined prior time period;
determining the exception period to have a duration greater than a predetermined time duration;
determining the exception period lasts less than a predetermined amount of time;
determining the data values in the exception period to be outside of a range of a predetermined time series data section; or
determining a changed time segment that has a preceding changed time segment and a following changed time segment from the same changed time series cluster.

16. The method of claim 13, wherein said detecting comprises:
scaling received time series data;
computing gamma that is an inverse of the 0.8 quantile of a kernel pairwise distance of points of the scaled time series data;
iterating over scaled time series data with sliding windows to calculate kernel pairwise scores;
detecting exception period based on comparing the changed time segment in the sliding windows and the scored time series data pairs;
identifying changed time segments in scored time series data pairs, based on predetermined peak values in the detected time series data pattern; and
generating a list of the pairs of change points corresponding to changed time segments.

17. The method of claim 16, wherein said iterating comprises:
responding to a mean of distance between a first pair and a next pair of change points being equal to or approximately zero, by indicating no change point detected between a first time segment and a next time segment; and
responding to a mean of kernel pairwise distance between a first pair and a next pair of change points being substantially greater than zero by indicating to store the first pair and the next pair of change points as a changed time segment.

18. The method of claim 14, wherein said hierarchical agglomerative clustering algorithm comprises:
arranging the changed time segment clusters according to a clock order.

19. The method of claim 10, wherein said cleaned time series data comprises non-seasonal baseline time series data.

20. A computer-readable storage medium having program instructions recorded thereon that, when executed by at least one processor, perform the method of claim 10.
